(19) United States
(12) Patent Application Publication
(10) Pub. No.: US 2006/0276581 A1
(43) Pub. Date: Dec. 7, 2006

(54) Plastic products with high strength and flexibility

(75) Inventors: Manfred Ratzsch, Wilhering (AT); Andreas Haider, Linz (AT); Uwe Muller, Luftenberg (AT); Andrea Gosweiner, Spittal/Phym (AT)

Correspondence Address: THE WEBB LAW FIRM, P.C., 700 KOPPERS BUILDING, 436 SEVENTH AVENUE, PITTSBURGH, PA, 15219, US

(73) Assignee: AMI AGROLINZ MELAMINE INTERNATIONAL GMBH, Linz (AT)

(21) Appl. No.: 10/565,354

(22) PCT Filed: Jul. 21, 2004
(86) PCT No.: PCT/EP04/08395

§ 371 Date: Jul. 12, 2006

(30) Foreign Application Priority Data
Jul. 22, 2003 (DE) 10333892.6

(51) Int. Cl. C08G 18/42

(52) U.S. Cl. 524/500

(57) ABSTRACT

The invention relates to plastic products with high strength and flexibility, having 10 to 50 mass % of at least one crosslinked thermoplast and 90 to 50 mass % of at least one crosslinked melamine resin ether. The invention further relates to a method for production of such a plastic product. The aim of the invention is the production of plastic objects in thermoplastics and duroplastics which can be produced by thermoplastic methodology and which have improved material properties.

The invention relates to plastics products composed of thermoplastics and of thermosets with high strength and flexibility, and also to a process for their production.

Plastics products which comprise thermoplastics and comprise thermosets are known.

U.S. Pat. No. 4,267,285 A and Trostyanskaya (Chemical Abstracts 68: 40623) describe glass fiber-reinforced thermoplastics, such as polypropylene, which comprise, as fillers, microparticles composed of crosslinked phenolic resins or of crosslinked melamine resins. A disadvantage is the restricted compatibility of the crosslinked thermoset particles with the thermoplastic matrix.

It is also known that thermoplastics, such as polyacrylamide (DE 23 64 091 A1), polyvinyl alcohol (EP 0 034 446 A1), and polyvinylpyrrolidone (JP 49 087 819 A2) can be added in proportions of up to 10% by weight during the production of melamine resin fibers by the wet spinning process. This addition of soluble thermoplastics as fiber-forming component permits filament formation but is disadvantageous in relation to the strength of the melamine resin fiber.

The invention is aimed at plastics products composed of thermoplastics and of thermosets which can be produced by thermoplastic processing methods and whose materials have improved properties.

The object of the invention was achieved via plastics products with high strength and flexibility, where according to the invention the plastics products are crosslinked semifinished products or molded materials based on interpenetrating networks which comprise from 10 to 50% by weight of at least one crosslinked thermoplastic and from 90 to 50% by weight of at least one crosslinked melamine resin ether.

The crosslinked thermoplastics are advantageously of the type represented by
ethylene-vinyl acetate copolymers and/or partially hydrolyzed ethylene-vinyl acetate copolymers whose vinyl acetate content is from 5 to 50% by weight, and/or
ethylene-acrylate copolymers and/or ethylene-methacrylate copolymers whose ethylene content is from 60 to 95 mol %, and/or
hydroxy-end-group-terminated aliphatic polyesters and/or polycaprolactones, and/or
poly(meth)acrylates whose content of hydroxy-C₁-C₆-alkyl(meth)acrylate in the molecule is from 2 to 10 mol %, and/or
polyethylenes grafted with C₁-C₈-alkyl methacrylate, and/or grafted with C₁-C₈-alkyl acrylate, and/or grafted with vinyl acetate, the amount of the graft being from 5 to 20% by weight, ethylene-C₃-C₈ olefin copolymers whose ethylene content is from 80 to 95 mol %, styrene-butadiene-styrene block copolymers, and/or styrene-ethylene-butadiene-styrene block copolymers, and/or
thermoplastic polyurethanes.

The crosslinked semifinished products or molded materials are advantageously produced via shaping and crosslinking of pseudoplastic melts of mixtures composed of melamine resin ethers whose weight-average molecular weights are from 1500 to 200 000 which advantageously comprise, based on the melamine resin ethers, from 0.1 to 2% by weight of hardener, and of thermoplastics which comprise, based on the thermoplastics, from 0.1 to 2% by weight of thermally decomposing free-radical generator.

The plastics products advantageously comprise, based in each case on the plastics products, from 10 to 70% by weight of fillers, adsorber materials, inorganic fibers, and/or synthetic fibers, from 1 to 15% by weight of hydrophobicizers, and/or from 1 to 10% by weight of flame retardants, from 0.1 to 2% by weight of pigments, and/or from 0.1 to 2% by weight of stabilizers, and/or from 0.1 to 5% by weight of auxiliaries.

It is preferable that the plastics products are injection moldings, or are tubes, sheets, or profiles.

Suitable partially hydrolyzed ethylene-vinyl acetate copolymers in the plastics products are crosslinked copolymers whose initial vinyl acetate content is from 4 to 50% by weight and in which from 5 to 50 mol % of the vinyl acetate groups have been hydrolyzed to give vinyl alcohol groups.

Examples of suitable hydroxy-end-group-terminated polyesters which can be present in the plastics products are polyesters based on saturated dicarboxylic acids, such as adipic acid and/or succinic acid, or on unsaturated dicarboxylic acids, such as maleic acid, fumaric acid, and/or itaconic acid, and diols, such as ethylene glycol, butanediol, neopentyl glycol, and/or hexanediol.

Examples of polyurethanes which can be present in the plastics products are crosslinked thermoplastic polyurethanes based on hexamethylene diisocyanate as diisocyanate component, and on diol components, such as butanediol, hexanediol, dodecanediol, and/or on polyalkylene glycols.

The fillers and adsorber materials present in the plastics products are preferably Al₂O₃, Al(OH)₃, SiO₂, barium sulfate, calcium carbonate, glass beads, siliceous earth, mica, powdered quartz, powdered slate, hollow microbeads, carbon black, talc, phyllosilicates, molecular sieves, rock flower, chalk, talc, cellulose, and/or cyclodextrines, preferred fillers being phyllosilicates of the type represented by montmorillonite, bentonite, kaolinite, muscovite, hectorite, fluorohectorite, kanemite, revdite, grumantite, ilerite, saponite, beidelite, nontronite, stevensite, laponite, taneolite, vermiculite, halloysite, volkonskoite, magadite, rectorite, kenyaite, sauconite, borofluorophlogopite, and/or synthetic smectites. Particularly preferred adsorber materials are phyllosilicates of the type represented by montmorillonite, bentonite, hectorite, molecular sieves of types A, X, Y, and in particular 5A, silicon-dioxide-based adsorbers, and/or hollow microbeads.

The inorganic fibers present in the plastics products are preferably glass fibers, rock fibers, or carbon fibers.

The synthetic fibers present in the plastics products are preferably polyester fibers or polyamide fibers.

The hydrophobicizer advantageously present in the plastics products are preferably organosilicon compounds of the type represented by organosilanols, organosiloxanes, organosilanes, organoaminosilanes, amino-end-group- or hydroxy-end-group-terminated polyorganosiloxanes; surface-fluorinated SiO₂ nanoparticles, polytetrafluoroethylene nanoparticles, and/or imide-group-containing copolymers of ethylenically unsaturated C₄-C₂₀ dicarboxylic anhydrides.

Examples of suitable flame retardants which can be present in the inventive plastics products are ammonium polyphosphate, sodium phosphate, melamine cyanurate, boron trioxide, boric acid, ammonium borate, and zinc borate.

Examples of suitable pigments which can be present in the inventive plastics products are iron oxide, ester-group-containing isoindoline pigments, fluorescent anthracene dyes, carbazole-dioxazine, and delta-indanthrone blue pigment.

Examples of suitable stabilizers which can be present in the inventive plastics products are UV stabilizers, such as 2-(2-hydroxy-3-tert-butyl-5-methylphenyl)benzo-triazole, 2,4-dihydroxybenzophenone, bis[2,2,6,6-tetramethyl-1-(octyloxy)-4-piperidyl]sebacate, or bis(2,2,6,6-tetramethyl-4-piperidyl)sebacate, and/or antioxidants, such as octadecyl 3-(3′,5′-di-tert-butyl-4′-hydroxyphenyl)propionate.

The auxiliaries present in the plastics products are preferably polymers of the type represented by non-etherified and/or partially etherified melamine resins whose melamine/formaldehyde molar ratio is from 1:1.5 to 1:4, lubricants of the type represented by zinc stearate, and/or magnesium stearate, and/or release agents of the type represented by talc, aluminum oxide, sodium carbonate, calcium carbonate, silica, or polytetrafluoroethylene powder.

The object is also achieved via a process with the features of claim 9. Here, the plastics product is produced via shaping and crosslinking of pseudoplastic melts of mixtures of melamine resins and of thermoplastics.

The plastics products with high strength and flexibility are by way of example produced by a process in which according to the invention plastics products in the form of crosslinked semifinished products or molded materials based on interpenetrating networks composed of

A) from 10 to 50% by weight of crosslinked thermoplastics of the type represented by
ethylene-vinyl acetate copolymers and/or partially hydrolyzed ethylene-vinyl acetate copolymers whose vinyl acetate content is from 5 to 50% by weight, and/or
ethylene-acrylate copolymers and/or ethylene-methacrylate copolymers whose ethylene content is from 60 to 95 mol %, and/or
hydroxy-end-group-terminated aliphatic poly-esters and/or polycaprolactones, and/or
poly(meth)acrylates whose content of hydroxy-C₁-C₆-alkyl(meth)acrylate in the molecule is from 2 to 10 mol %, and/or
polyethylenes grafted with C₁-C₈-alkyl methacrylate, and/or grafted with C₁-C₈-alkyl acrylate, and/or grafted with vinyl acetate, the amount of the graft being from 5 to 20% by weight, ethylene-C₃-C₈ olefin copolymers whose ethylene content is from 80 to 95 mol %, styrene-butadiene-styrene block copolymers, and/or styrene-ethylene-butadiene-styrene block copolymers, and/or
thermoplastic polyurethanes and of

B) from 90 to 50% by weight of crosslinked melamine resin ethers,
where the plastics products may comprise, based in each case on the plastics products, from 10 to 70% by weight of fillers, adsorber materials, inorganic fibers, and/or synthetic fibers, from 1 to 10% by weight of flame retardants, from 0.1 to 2% by weight of pigments, from 0.1 to 2% by weight of stabilizers, and/or from 0.1 to 5% by weight of auxiliaries,
are produced by an extruder process in which
in the first stage of the process, in extruders whose length is from 30 to 60 D, equipped with side-feed equipment for solid and liquid substances and vacuum devolatilization
in the first extruder segment, melt mixtures composed of melamine resin ethers whose weight-average molecular weights are from 1500 to 200 000
and whose melamine/formaldehyde molar ratio is from 1:1.5 to 1:4 and of thermoplastics, are prepared at melt temperatures of from 100 to 170° C, where the mixture components here can be fed collectively into the feed hopper, or the melamine resin ether can be fed into the thermoplastic melt by way of side-feed equipment after melting of the thermoplastic, or the thermoplastic can be fed into the thermoplastic melt by way of side-feed equipment after melting of the melamine resin ether, and then the melt mixture is devolatilized after homogenization and
in the second extruder segment, at melt temperatures of from 100 to 150° C. in the melt mixture, from 0.1 to 2% by weight, based on the melamine resin ethers, of hardener, and from 0.1 to 2% by weight, based on the thermoplastics, of thermally decomposing free-radical generator are fed and homogenized in the melt mixture, where hardener and/or thermally decomposing free-radical generator can be used in the form of masterbatch comprising from 60 to 90% by weight of thermoplastic
and where, based in each case on the entirety of melamine resin ether and thermoplastic, from 10 to 70% by weight of fillers, adsorber materials, inorganic fibers, and/or synthetic fibers, from 1 to 10% by weight of flame retardants, from 0.1 to 2% by weight of pigments, from 0.1 to 2% by weight of stabilizers, and/or from 0.1 to 5% by weight of auxiliaries can be fed into the extruder in the first and/or second extruder segment and
in the second stage of the process, the melt mixture
is either discharged from the extruder and pelletized, the molding composition pellets being melted in a third stage of the process at temperatures of from 150 to 240° C. and the pseudoplastic melt being processed in presses, extruders, or injection molding machines, with crosslinking, to give semifinished products or molded materials
or is heated in a third extruder segment at temperatures of from 150 to 240° C., the pseudoplastic melt being discharged, with crosslinking, through a die, and being drawn off in the form of a semifinished product.

It is possible that all of the process parameters mentioned in the example are present together, or else they may be present individually, in this form. In the extruder process it is preferable to use twin-screw extruders or extruders with a plunger screw.

The plastics product can advantageously be produced by a sintering process. An example of this embodiment for production of plastics products with high strength and flexibility is presented below, where plastics products are produced in the form of crosslinked semifinished products or molded materials based on interpenetrating networks which are composed of

A) from 10 to 50% by weight of crosslinked thermoplastics of the type represented by
ethylene-vinyl acetate copolymers and/or partially hydrolyzed ethylene-vinyl acetate copolymers whose vinyl acetate content is from 5 to 50% by weight, and/or
ethylene-acrylate copolymers and/or ethylene-methacrylate copolymers whose ethylene content is from 60 to 95 mol %, and/or
hydroxy-end-group-terminated aliphatic poly-esters and/or polycaprolactones, and/or
poly(meth)acrylates whose content of hydroxy-C₁-C₆-alkyl(meth)acrylate in the molecule is from 2 to 10 mol %, and/or
polyethylenes grafted with C₁-C₈-alkyl methacrylate, and/or grafted with C₁-C₈-alkyl acrylate, and/or grafted with vinyl acetate, the amount of the graft being from 5 to 20% by weight, ethylene-C₃-C₈ olefin copolymers whose ethylene content is from 80 to 95 mol %, styrene-butadiene-styrene block copolymers, and/or styrene-ethylene-butadiene-styrene block copolymers, and/or
thermoplastic polyurethanes and of

B) from 90 to 50% by weight of crosslinked melamine resin ethers, where the plastics products may comprise, based in each case on the plastics products, from 10 to 70% by weight of fillers, adsorber materials, inorganic fibers, and/or synthetic fibers, from 1 to 10% by weight of flame retardants, from 0.1 to 2% by weight of pigments, from 0.1 to 2% by weight of stabilizers, and/or from 0.1 to 5% by weight of auxiliaries, are produced by a sintering process in which
in the first stage of the process, mixtures composed of melamine resin ethers whose weight-average molecular weights are from 1500 to 200 000 and whose melamine/formaldehyde molar ratio is from 1:1.5 to 1:4, of thermoplastics, and, if appropriate, of fillers, adsorber materials, inorganic fibers, and/or synthetic fibers are sintered in high-speed mixers using residence times of from 3 to 30 min and final temperatures of from 90 to 160° C., the sinter mixture is cooled to temperatures of from 50 to 120° C., and, after cooling, from 0.1 to 3% by weight, based on the melamine resin ether, of hardener, and from 0.1 to 2% by weight, based on the thermoplastics, of thermally decomposing free-radical generator, and, if appropriate, from 1 to 10% by weight, based in each case on the entirety of melamine resin ether and thermoplastic, of flame retardants, from 0.1 to 2% by weight of pigments, from 0.1 to 2% by weight of stabilizers, and/or from 0.1 to 5% by weight of auxiliaries are applied in a drum mixer to the sinter mixture and
in the second stage of the process, the sintered mixture is melted at temperatures of from 150 to 240° C., and the pseudoplastic melt is processed in presses, extruders, or injection-molding machines, with crosslinking, to give semifinished products or molded materials.

In this example, too, the process parameters can be present together or individually.

In the sintering process, heat is introduced in the internal mixer not only via frictional heating but also via jacket heating.

The melamine resin ethers used in the inventive processes for the production of plastics products are preferably etherified melamine resin condensates which are free from hydroxymethyleneamino groups bonded to the triazine rings of the melamine resin condensate, and from —NH—CH₂—O—CH₂—NH— groups linking triazine rings, and in which C₁-C₁₈ alcohols and/or diols with molecular weights of from 62 to 20 000 have been used for the etherification of the hydroxymethylamino groups. The melamine resin ethers used for the production of the plastics products are preferably obtained via etherification of melamine resin precondensates with C₁-C₄ alcohol, if appropriate with subsequently partial transetherification with C₄-C₁₈ alcohols, with C₂-C₁₈ diols, with polyhydric alcohols of the type represented by glycerol or pentaerythritol, with C₅-C₁₈ amino alcohols, with polyalkylene glycols, with hydroxy-end-group-containing polyesters, with siloxane polyesters, with siloxane polyethers, with melamine-alkylene oxide adducts, and/or with two-ring phenol-alkylene oxide adducts, and subsequent thermal condensation of the melamine resin ethers in the melt in a continuous kneader at temperatures of from 140 to 220° C.

In production of the plastics products it is advantageous to use copolymers composed of ethylene and of unsaturated esters, and/or to use partially hydrolyzed ethylene-vinyl acetate copolymers.

Suitable ethylene-vinyl acetate copolymers in production of the plastics products are copolymers whose vinyl acetate content is from 4 to 50% by weight and whose melt indices are in the range from 0.5 to 400 g/10 min at 190° C./2.16 kp.

Suitable partially hydrolyzed ethylene-vinyl acetate copolymers in the production of the plastics products are copolymers whose initial vinyl acetate content is from 4 to 50% by weight and whose melt indices are in the range from 0.5 to 400 g/10 min at 190° C./2.16 kp, and in which from 5 to 50 mol % of the vinyl acetate groups have been hydrolyzed to give vinyl alcohol groups.

Ethylene copolymers with high vinyl acetate content can be used in the form of talc-powdered pellets to improve feed performance.

The grafted ethylene-vinyl acetate copolymers which can be used in the process variants for the production of plastics products are preferably products whose melt indices are from 10 to 80 g/10 min at 190° C./2.16 kp. The graft copolymers can be prepared via modification of the copolymers with the appropriate monomers in the melt, or via solid-phase modification, the copolymers prepared in these processes being in fine-particle powder form.

Examples of suitable polycaprolactones which can be used in the process variants for the production of plastics products are polycaprolactones whose densities are from 1.05 to 1.15 g/cm³ at 60° C., whose viscosities are in the range from 500 to 5000 Pas at 100° C., and whose melt indices are in the range from 2 to 80 g/10 min at 160° C./2.16 kp. The polycaprolactones can likewise be adducts of ethylene oxide onto polycaprolactone.

In the inventive process for the production of plastics products, it is preferable to use, as hardener for the melamine resin ethers, acidifiers of the type represented by blocked sulfonic acids, aliphatic C₄-C₁₈ carboxylic acids; aromatic C₇-C₁₈ carboxylic acids; alkali metal salts or ammonium salts of phosphoric acid; C₁-C₁₂-alkyl ethers or C₂-C₈-hydroxyalkyl esters of C₇-C₁₄-aromatic carboxylic acids, or of inorganic acids; salts of melamine or of guanamines with C₁-C₁₈-aliphatic carboxylic acids; anhydrides, half esters or half amides of C₄-C₂₀ dicarboxylic acids; half esters or half amides of copolymers composed of ethylenically unsaturated C₄-C₂₀ dicarboxylic anhydrides and of ethylenically unsaturated monomers of the type represented by C₂-C₂₀ olefins and/or C₈-C₂₀ vinylaromatics; and/or salts of C₁-C₁₂ alkylamines and, respectively, alkanolamines with C₁-C₁₈-aliphatic, C₇-C₁₄-aromatic, or alkylaromatic carboxylic acids, and also with inorganic acids of the type represented by hydrochloric acid, sulfuric acid, or phosphoric acid.

Examples of block sulfonic acids as hardeners for the melamine resin ethers are benzil monooxime tosylate, benzil monooxime p-dodecylbenzenesulfonate, 4-chloro-α-trifluoroacetophenone oxime benzenesulfonate, and 2-pentafluorophenylsulfonyloxyimino-4-phenylbut-3-eno-nitrile.

Examples of aliphatic C₄-C₁₈ carboxylic acids as hardeners for the melamine resin ether are caproic acid, palmitic acid, stearic acid, and oleic acid.

Examples of aromatic C₇-C₁₈ carboxylic acids as hardeners for the melamine resin ethers are benzoic acid, phthalic acid, or naphthalenedicarboxylic acid.

Examples of alkali metal salts or ammonium salts of phosphoric acid as hardeners for the melamine resin ethers are ammonium hydrogenphosphate, sodium polyphosphate, and potassium hydrogenphosphate.

Examples of C₁-C₁₂-alkyl esters or C₂-C₈-hydroxyalkyl esters or C₇-C₁₄-aromatic carboxylic acids as hardeners for the melamine resin ethers are dibutyl phthalate, diglycol phthalate, and/or glycol trimellitate.

Examples of salts of melamine or of guanamines with C₁-C₁₈-aliphatic carboxylic acids as hardeners for the melamine resin ethers are melamine formate, melamine citrate, melamine maleate, melamine fumarate, and/or acetoguanamine butyrate.

Examples of anhydrides, half esters, or half amides of C₄-C₂₀ dicarboxylic acids as hardeners for the melamine resin ethers are maleic anhydride, succinic anhydride, phthalic anhydride, mono-C₁-C₁₈-alkyl maleates, maleic monoamide, or mono-C₁-C₁₈ alkyl maleamides.

Examples of mono-C₁-C₁₈-alkyl maleates as hardeners for the melamine resin ethers are monobutyl maleate, monoethylhexyl maleate, or monostearyl maleate.

Examples of mono-C₁-C₁₈-alkyl maleamides as hardeners for the melamine resin ethers are monoethyl maleamide, monooctyl maleamide, or monostearyl maleamide.

Examples of half esters or half amides of copolymers composed of ethylenically unsaturated C₄-C₂₀ dicarboxylic anhydrides and of ethylenically unsaturated monomers of the type represented by C₂-C₂₀ olefins and/or C₈-C₂₀ vinylaromatics as hardeners for the melamine resin ethers are half esters or half amides of copolymers composed of maleic anhydride and of C₃-C₈ α-olefins of the type represented by isobutene, diisobutene, and/or 4-methylpentene, and/or styrene whose molar ration of maleic anhydride to C₃-C₈ α-olefin and, respectively, styrene and, respectively, appropriate monomer mixtures is from 1:1 to 1:5.

Examples of salts of C₁-C₁₂-alkylamines and, respectively, alkanolamines with C₁-C₈-aliphatic, C₇-C₁₂-aromatic and, respectively, alkylaromatic carboxylic acids or with inorganic acids of the type represented by hydrochloric acid, sulfuric acid, or phosphoric acid as hardeners for the melamine resin ethers are ethanolammonium chloride, triethylammonium maleate, diethanolammonium phosphate, and/or isopropyl ammonium p-toluenesulfonate.

In the inventive process for the production of plastics products, thermally decomposing free-radical generators used for the crosslinking of the thermoplastic component are preferably free-radical generators whose thermal decomposition has been concluded below 210° C., of the type represented by acyl peroxides, alkyl peroxides, hydroperoxides, peroxycarbonates, and/or peresters.

Examples or suitable acyl peroxides which can be used as thermally decomposing free-radical generators in the production of plastics products are benzoyl peroxide, 4-chlorobenzoyl peroxide, 3-methoxybenzoyl peroxide, and methylbenzoyl peroxide.

Examples of suitable alkyl peroxides which can be used as thermally decomposing free-radical generators during the production of plastics products are allyl tertbutyl peroxide, 1,1-bis(tert-butylperoxy)-3,3,5-trimethylcyclohexane, diethylaminomethyl tert-butyl peroxide, dicumyl peroxide, tert-butyl cumyl peroxide, di(tert-butylperoxyisopropyl)benzene, 1,1-di(tert-butylperoxy)-3,3,5-trimethylcyclohexane, 3,6,9-triethyl-3,6,9-trimethyl-1,4,7-triperoxonane, and tert-butyl peroxide.

Examples for suitable peresters and peroxycarbonates which can be used as thermally decomposing free-radical generators in the production of plastics products are butyl peracetate, cumyl peracetate, cumyl perpropionate, cyclohexyl peracetate, di-tert-butyl peradipate, tert-butyl cyclobutanepercarboxylate, tert-butyl 2-propylperpent-2-enoate, tert-butyl 1-methyl-cypropylpercarboxylate, tert-butyl peroxyisopropyl carbonate, and tert-butyl perpropionate.

If ethylene-vinyl acetate copolymers and/or partially hydrolyzed ethylene-vinyl acetate copolymers are used as thermoplastics in the production processes for plastics products, the crosslinking required can likewise be achieved via addition of alkali metal alkoxylates, such as sodium methoxide, potassium methoxide, or sodium tert-butoxide.

The particular advantage of the inventive plastics products consists in their high strength and flexibility, which results from the interpenetrating network structure of the plastics components.

Plastics products with interpenetrating network structure cannot be produced by thermoplastic processing methods starting from mixtures composed of conventional low-viscosity melamine resins and of low-viscosity thermoplastics, a precondition for thermoplastic processibility being pseudoplastic behavior of the plastics melt. In the mixtures composed of thermoplastics and of melamine resins, pseudoplastic behavior of the melt was achieved by using, as melamine resins, melamine resin ethers whose weight-average molecular weights are from 1500 to 200 000.

Thermoplastic processing of mixtures requires similar melt viscosities of the mixture components in order to avoid demixing of the components. In the second stage of the inventive process for the production of the plastics products, the melt viscosity of the melamine resin ether component increases continuously during the shaping to give the product as a consequence of the curing procedure. In this stage of the process, the molecular weight increase brought about by the thermally decomposing free-radical generator added gives the required adjustment of the melt viscosity of the thermoplastic component. The parallel process of crosslinking of the thermoplastic component and thermoset component in the second stage of the process forms interpenetrating network structures with advantageous strength properties and flexibility properties for the plastics products.

Preferred application sectors for the inventive plastics products are the vehicle industry, mechanical engineering, electrical engineering, and electronics.

The examples below illustrate the invention.

### EXAMPLE 1

1.1 Preparation of the Thermoplastically Processible Melamine Resin Ether

A melamine dispersion is prepared in a 30 l stirring autoclave via introduction of 1.0 kg of melamine into 13.9 kg of methanol at 95° C., and after adjustment to a pH of 5.9 using 10% HCl, 2.5 kg of a 37% formaldehyde solution preheated to 60° C. is fed under pressure into the stirred autoclave, and the reaction mixture is reacted at a reaction temperature of 95° C. for a reaction time of 20 min.

After cooling to 65° C., a pH of 9 is set via addition of 10% sodium hydroxide solution, and the etherified melamine resin condensate dissolved in the water-methanol mixture is, after addition of 2.23 kg of butanol, transferred to a first vacuum evaporator in which the solution of the etherified melamine resin condensate is concentrated at 82° C. to give a highly concentrated melamine resin solution whose solids content is 76% by weight and whose butanol content is 8% by weight.

The highly concentrated solution of the etherified melamine resin is then transferred to a second vacuum evaporator and concentrated at 90° C. to give a syrupy melt whose solids content is 96% by weight.

The syrupy melt is mixed in a mixing section with 1.0 kg of polyethylene glycol (molecular weight 800), fed into the feed hopper of a GL 27 D44 laboratory extruder with vacuum devolatilization zones downstream of the feed zone and also downstream of the reaction zone upstream of product discharge, temperature profile 200/215/215/240/240/215/215/200/105/95° C., extruder rotation rate 300 rpm, the reaction mixture is devolatilized at 850 mbar, and the emerging extrudate is chopped in a pelletizer. The pellets are powdered with 0.3% by weight of talc to improve feed performance.

The weight-average molecular weight of the etherified melamine resin condensate (GPC) is 20 000 and its content of butoxy groups is 0.3% by weight. The IR spectrum reveals no hydroxymethyleneamino groups bonded to the triazine rings of the melamine resin condensate and no —NH—CH₂—O—CH₂—NH— groups linking triazine rings.

1.2 Production of the Crosslinked Plastics Product

4.5 kg/h of the etherified melamine resin condensate of 1.1 and 1.5 kg/h of an ethylene-vinyl acetate copolymer (vinyl acetate content 28% by weight, melt index 25 g/10 min at 190° C./2.16 kp) are fed into the feed hopper of a ZSK 30 Werner&Pfleiderer extruder, LD=48 with side feed for solid and liquid substances, vacuum devolatilization, and 4.0×100 sheet die, and are melted at 130° C. 5.5 kg/h of aminosilane-sized glassfibers (average diameter 0.08 mm) are drawn from the roving into the melt of the melamine resin ether by way of a side feed, and the glassfiber-containing melt is homogenized at a melt temperature of 130° C. and devolatilized at 850 mbar.

After the devolatilization, 0.40 kg/h of an EVA masterbatch which comprises 8% by weight of 2-(2-hydroxy-3-tert-butyl-5-methylphenyl)benzotriazole, 20% by weight of monostearyl maleate, 5% by weight of tert-di-tert-butyl peroxide, and 15% by weight of zinc stearate, and 0.84 kg/h of ammonium polyphosphate are metered into the glassfiber-containing melt, homogenized at a melt temperature of 180° C., discharged via a 4×100 mm sheet die, and drawn off in the form of a crosslinked web.

The flexural modulus of test specimens stamped out from the glassfiber-reinforced plastics sheet is 72×10⁸ N/m².

### EXAMPLE 2

2.1 Production of the Thermoplastically Processible Melamine Resin Ether

A melamine dispersion is prepared in a 30 l stirring autoclave via introduction of 1.0 kg of melamine into 15 kg of methanol at 95° C., and after adjustment to a pH of 6.1, 3.0 kg of a 37% formaldehyde solution preheated to 92° C. is fed under pressure into the stirred autoclave, and the reaction mixture is reacted at a reaction temperature of 95° C. for a reaction time of 6 min.

After cooling to 65° C., a pH of 9.2 is set via addition of 10% sodium hydroxide solution, and the etherified melamine resin condensate dissolved in the water-methanol mixture is, after addition of 0.6 kg of butanol, transferred to a first vacuum evaporator in which the solution of the etherified melamine resin condensate is concentrated at 80° C. to give a highly concentrated melamine resin solution whose solids content is 78% by weight and whose butanol content is 3% by weight.

The highly concentrated solution of the etherified melamine resin is then mixed in a mixing section with 0.8 kg of Simulsol BPLE (oligoethylene glycol ether of bisphenol A, Seppic, France), transferred to a second vacuum evaporator and concentrated at 90° C. to give a syrupy melt whose solids content is 98% by weight.

The syrupy melt is fed into the feed hopper of a GL 27 D44 (Leistritz) laboratory extruder with vacuum devolatilization zones downstream of the feed zone and also downstream of the reaction zone upstream of product discharge, temperature profile 200/215/215/240/240/215/215/200/105/95° C., extruder rotation rate 300 rpm, the reaction mixture is devolatilized at 850 mbar, and the emerging extrudate is chopped in a pelletizer.

The weight-average molecular weight of the etherified melamine resin condensate (GPC) is 10 000 and its content of butoxy groups is 3% by weight. The IR spectrum reveals no hydroxymethyleneamino groups bonded to the triazine rings of the melamine resin condensate and no —NH—CH₂—O—CH₂—NH— groups linking triazine rings.

The pellets of the melamine resin ether are powdered with 0.3% by weight of talc to improve feed performance.

2.2 Production of the Plastics Product

4.5 kg/h of the thermoplastically processible melamine resin ether of 2.1 are fed into the feed hopper of a ZSK 30 Werner&Pleiderer twin-screw extruder, L/D 48, and are melted at a melt temperature of 120° C. 3.2 kg/h of a 1:1 mixture composed of chalk and talc are fed into the melt of the melamine resin ether by way of a side feed and homogeneously distributed in the melt at 120° C., and the mixture is subjected to vacuum devolatilization at 800 mbar. After devolatilization, 1.5 kg/h of a 1:1 pellet mixture composed of an ethylene-vinyl acetate copolymer (vinyl acetate content 12% by weight, melt index 12 g/10 min at 190° C./2.16 kp) and of a corresponding partially hydrolyzed ethylene-vinyl acetate copolymer (30 mol % of the vinyl acetate groups hydrolyzed, melt index 20 g/10 min at 190° C./2.16 kp), 0.8 kg/h of ammonium polyphosphate, 0.8 kg/h of a EVA masterbatch which comprises 10% by weight of phthalic anhydride, 10% by weight of magnesium stearate, 3% by weight of dicumyl peroxide, and 20% by weight of bis(2,2,6,6-tetramethyl-4-piperidyl)sebacate are fed into the melt at a melt temperature of 130° C., and the melt is discharged and pelletized. The molding composition is melted at 180° C. in an extruder with a U-profile die, discharged via the U-profile die, and drawn off in the form of a crosslinked profile.

The flexural modulus of test specimens stamped out from the profile is 25×10⁸ N/mm² and their tensile strain at break is 3.8%.

### EXAMPLE 3

3.1 Preparation of the Blend Composed of Thermoplastically Processible Melamine Resin Ether and of Grafted Ethylene Polymer

A melamine dispersion is prepared in a 30 l stirring autoclave via introduction of 1.0 kg of melamine into 13.9 kg of methanol at 95° C., and after adjustment to a pH of 5.9 using 10% HCl, 2.5 kg of a 37% formaldehyde solution preheated to 60° C. is fed under pressure into the stirred autoclave, and the reaction mixture is reacted at a reaction temperature of 95° C. for a reaction time of 20 min.

After cooling to 65° C., a pH of 9 is set via addition of 10% sodium hydroxide solution, and the etherified melamine resin condensate dissolved in the water-methanol mixture is, after addition of 2.23 kg of butanol, transferred to a first vacuum evaporator in which the solution of the etherified melamine resin condensate is concentrated at 82° C. to give a highly concentrated melamine resin solution whose solids content is 76% by weight and whose butanol content is 8% by weight.

The highly concentrated solution of the etherified melamine resin is then transferred to a second vacuum evaporator and concentrated at 90° C. to give a syrupy melt whose solids content is 96% by weight.

The syrupy melt is mixed in a mixing section with 1.6 kg of polyethylene glycol (molecular weight 1000). 4.5 kg/h of the reaction mixture are fed into the feed hopper of a GL 27 D44 laboratory extruder with vacuum devolatilization zones downstream of the feed zone and also downstream of the reaction zone upstream of product discharge, and side feed, temperature profile 195/195/195/195/250/250/250/250/140/100° C., extruder rotation rate 250 rpm, and 1.5 kg/h of an ethylene-vinyl acetate copolymer grafted with 9% by weight of vinyl acetate (24% by weight of vinyl acetate in the main chain, melt index 8 g/10 min at 190° C./2.16 kp) are fed by way of the side feed, and homogenized. The blend is devolatilized at 850 mbar, and the emerging extrudate is chopped in a pelletizer. The pellets are powdered with 0.3% by weight of talc to improve feed performance.

3.2 Production of the Plastics Product

6.2 kg of cellulose fibers (average length 1.8 mm, average diameter 0.2 mm) are introduced into a high-speed mixer (internal volume 40 l, 75° C. jacket heating), and fluidized at 900 rpm. 7.0 kg of the pellets of 3.1 are fed into this material and the rotation rate is increased to 1800 rpm until the temperature of the mixture has reached 125° C. The rotation rate is lowered again to 900 rpm, and, after cooling until the temperature of the material is 90° C., 110 g of dihydroxybenzophenone, 750 g of sodium borate, 40 g of phthalic anhydride, and 30 g of di-tert-butyl perbenzoate are applied to the fluidized sinter mixture in the drum mixer and the sinter mixture is discharged. The sinter mixture comprising cellulose fibers is melted at 160° C. in a sheet mold, and pressed at a pressure of 45 bar.

The flexural modulus of test specimens stamped out from the sheet is 38×10⁸ N/m² and their tensile strain at break is 4.3%.

### EXAMPLE 4

3.6 kg/h of an ethylene-vinyl acetate copolymer (vinyl acetate content 28% by weight, melt index 25 g/10 min at 190° C./2.16 kp) and 4.1 kg/h of the etherified melamine resin condensate of 1.1 are fed into the feed hopper of a Leistritz GL 27 D 44 laboratory extruder with side feed for solid and liquid substances, vacuum devolatilization, and 4.0×100 sheet die, and are melted at 130° C. 6.2 kg/h of polyethylene terephthalate fibers (3.3 dtex) are drawn from the roving into the melt by way of a side feed, and the melt comprising polyethylene terephthalate fibers is homogenized at a melt temperature of 130° C. and devolatilized at 850 mbar.

After the devolatilization, 1.0 kg/h of ammonium polyphosphate and 0.84 kg/h of a polyethylene wax masterbatch comprising 8% by weight of sodium methoxide, 10% by weight of tert-butyl cumyl peroxide, 20% by weight of 2-(2-hydroxy-3-tert-butyl-5-methylphenyl)benzotriazole, 8% by weight of monostearyl maleate, and 10% by weight of zinc stearate are fed into the melt comprising polyethylene terephthalate fibers at a melt temperature of 150° C., and are homogenized at a melt temperature of 175° C., discharged via a 4×100 mm sheet die, and drawn off in the form of a crosslinked web.

The flexural modulus of test specimens stamped out from the plastics product is 25×10⁸ N/m², and their tensile strain at break is 8.2%.

### EXAMPLE 5

4.9 kg/h of the etherified melamine resin condensate of 2.1 and 2.6 kg/h of an ethylene-butyl acrylate copolymer (butyl acrylate content 12% by weight, melt index 35 g/10 min at 190° C./2.16 kp) are fed into the feed hopper of a ZSK 30 Werner&Pfleiderer twin-screw extruder, L/D 48, and are melted at a melt temperature of 145° C. 8 kg/h of polyamide fibers (3.2 dtex) are drawn from the roving into the polyolefin melt by way of a side feed, and homogeneously distributed in the melt at 145° C., and the mixture is subjected to vacuum devolatilization at 850 mbar. After devolatilization, 1.0 kg/h of sodium borate, 1.0 kg/h of an EVA masterbatch comprising 25% by weight of 2-(2-hydroxy-3-tert-butyl-5-methylphenyl)benzotriazole, 7% by weight of monostearyl maleate, 3% by weight of di-tert-butyl peroxide, and 30% by weight of zinc stearate are fed into the melt at a melt temperature of 130° C., and the melt comprising polyamide fibers is discharged and pelletized. The molding composition comprising polyamide fibers is melted in an extruder with square-profile die at 170° C., discharged via the square-profile die, and drawn off in the form of a crosslinked profile.

The flexural modulus of test specimens stamped out from the profile is 26×10⁸ N/m², and their tensile strain at break is 6.4%.

### EXAMPLE 6

6.1 Preparation of the Blend Composed of Thermoplastically Processible Melamine Resin Ether and Polycaprolactone

Downstream of the second vacuum evaporator, the syrupy melt of the melamine resin ether of 3.1 is mixed in a mixing section with 0.8 kg of polyethylene glycol (molecular weight 1000), and 5.0 kg/h of the reaction mixture are fed into the feed hopper of a GL 27 D 44 laboratory extruder with vacuum devolatilization zone downstream of the feed zone and also downstream of the reaction zone, prior to product discharge, and side feed, temperature profile 200/215/215/240/240/215/215/200/105/95° C., extruder rotation rate 300 rpm. 3.0 kg/h of polycaprolactone (Capa 6500, Solvay, density 1.1 g/cm³ at 60° C., viscosity 1500 Pas at 100° C., melt index 7.2 g/10 min at 160° C./2.16 kp) are fed into the melt by way of the side feed, and are homogenized. The blend is devolatilized at 850 mbar, and the emerging extrudate is chopped in a pelletizer. The pellets are powdered with 0.3% by weight of talc to improve feed performance.

6.2 Production of the Plastics Product

4 kg of montmorillonite and 2 kg of cellulose fibers (average length 1.8 mm, average diameter 0.2 mm) are introduced into a high-speed mixer (internal volume 40 l, 75° C. jacket heating), and are fluidized at 900 rpm. 5.0 kg of the pellets of 6.1 are fed into this material, and the rotation rate is increased to 1800 rpm until the temperature of the material has reached 125° C. The rotation rate is then lowered again to 900 rpm and, after cooling until the temperature of the material is 90° C., 110 g of dihydroxybenzophenone, 250 g of sodium borate, 40 g of phthalic anhydride, and 15 g of di-tert-butyl perbenzoate are applied to the fluidized sinter mixture in the drum mixer; and the sinter mixture is discharged.

The sinter mixture comprising montmorillonite and comprising cellulose fibers is melted at 160° C. in a sheet mold, and pressed at a pressure of 45 bar.

The flexural modulus of test specimens stamped out from the sheet is 39×10⁸ N/m², and their tensile strain at break is 6.2%.

### EXAMPLE 7

4.1 kg of cellulose-polyethylene terephthalate 1:1 mixed fibers (average length 2.2 mm, average diameter 0.15 mm) are introduced into a high-speed mixer (internal volume 40 l, 75° C. jacket heating), and are fluidized at 900 rpm. 4.0 kg of the pellets of 3.1 and 3 kg of an aliphatic polyurethane based on hexamethylene diisocyanate and dodecane diol (melt index 160 g/10 min at 190° C./2.16 kp) are fed into this material, and the rotation rate is increased to 2500 rpm until the temperature of the material has reached 155° C. The rotation rate is lowered again to 900 rpm and, after cooling until the temperature of the material is 90° C., 110 g of dihydroxybenzophenone, 250 g of sodium borate, 40 g of phthalic anhydride, and 30 g of di-tert-butyl perbenzoate are applied to the fluidized sinter mixture in the drum mixer, and the sinter mixture is discharged.

The sinter mixture is processed at a melt temperature of 195° C. and a mold temperature of 50° C. in a Ferromatic Millacron FM 60 injection-molding machine (three-zone screw, L=22 D) to give crosslinked standard test specimens. The flexural modulus of the standard test specimens is 25.5×10⁸ Nm², and their tensile strain is 7.5%.

1-29. (canceled)

30. A plastics product of high strength and flexibility, wherein the plastics product is at least one of a crosslinked semifinished product or a crosslinked molded material based on interpenetrating networks and comprises from 10 to 50% by weight of at least one crosslinked thermoplastic and from 90 to 50% by weight of at least one crosslinked melamine resin ether, wherein the at least one of the crosslinked semifinished product or the crosslinked molded material has been produced from a mixture composed of thermoplastics which comprise, based on the total weight of the thermoplastics, from 0.1 to 2% by weight of a thermally decomposing free-radical generator, and melamine resin ethers which comprise, based on the total weight of the melamine resin ethers, from 0.1 to 2% by weight of a hardener.

31. The plastics product of claim 30, wherein the thermoplastic is at least one of
an ethylene-vinyl acetate copolymer,
a partially hydrolyzed ethylene-vinyl acetate copolymer whose vinyl acetate content is from 5 to 50% by weight,
an ethylene-acrylate copolymer,
an ethylene-methacrylate copolymer whose ethylene content is from 60 to 95 mol %,
a hydroxy-end-group-terminated aliphatic polyester,
a polycaprolactone,
a poly(meth)acrylate whose content of hydroxy-C₁-C₆-alkyl(meth)acrylate in the molecule is from 2 to 10 mol %,
a polyethylene grafted with from 5 to 20% by weight of a vinyl acetate or C₁-C₈-alkyl acrylate,
a C₁-C₈-alkyl-methacrylate-grafted polyethylene,
an ethylene-C₃-C₈ olefin copolymer whose ethylene content is from 80 to 95 mol %,
a styrene-butadiene-styrene block copolymer,
a styrene-ethylene-butadiene-styrene block copolymer, or a thermoplastic polyurethane.

32. The plastics product of claim 30, wherein the at least one melamine resin ether has a weight-average molecular weight of from 1500 to 200 000 and a molar melamine/formaldehyde ratio of from 1:1.5 to 1:4.

33. The plastics product of claim 30, further comprising at least one of the following and based in each case on the plastics products, from 10 to 70% by weight of fillers, adsorber materials, inorganic fibers, or synthetic fibers, from 1 to 15% by weight of hydrophobicizers, from 1 to 10% by weight of flame retardants, from 0.1 to 2% by weight of pigments, from 0.1 to 2% by weight of stabilizers, from 0.1 to 5% by weight of auxiliaries.

34. The plastics product as claimed in claim 33, wherein the fillers and adsorber materials are selected from the group consisting of Al₂O₃, Al(OH)₃, SiO₂, barium sulfate, calcium carbonate, glass beads, siliceous earth, mica, powdered quartz, powdered slate, hollow microbeads, carbon black, talc, phyllosilicates, molecular sieves, rock flower, chalk, talc, cellulose, and cyclodextrines, such as fillers being phyllosilicates selected from the group consisting of montmorillonite, bentonite, kaolinite, muscovite, hectorite, fluorohectorite, kanemite, revdite, grumantite, ilerite, saponite, beidelite, nontronite, stevensite, laponite, taneolite, vermiculite, halloysite, volkonskoite, magadite, rectorite, kenyaite, sauconite, borofluorophlogopite, and synthetic smectites, such as adsorber materials being phyllosilicates selected from the group consisting of montmorillonite, bentonite, hectorite, molecular sieves of types A, X, Y, 5A, silicon-dioxide-based adsorbers, and hollow microbeads.

35. The plastics product as claimed in claim 33, wherein at least one hydrophobicizer is an organosilicon compound selected from the group consisting of organosilanols, organosiloxanes, organosilanes, organoaminosilanes, amino-end-group- or hydroxy-end-group-terminated polyorganosiloxanes; surface-fluorinated SiO₂ nanoparticles, polytetrafluoroethylene nanoparticles, and imide-group-containing copolymers of ethylenically unsaturated C₄-C₂₀ dicarboxylic anhydrides.

36. The plastics product as claimed in claim 30, wherein the plastics product is an injection molding or is a tube, sheet, or profiles.

37. A process for the production of a plastics product, as claimed in claim 30, wherein the plastics product is produced via shaping and crosslinking of pseudoplastic melts of mixtures of melamine resin ethers and of thermoplastics.

38. The process as claimed in claim 37, wherein the plastics product is produced by an extruder process wherein, in a first stage of the process and in a first extruder segment, melt mixtures composed of melamine resin ethers and of thermoplastics are prepared and then the melt mixture is devolatilized after homogenization,
and in a second extruder segment, hardener and also decomposing free-radical generator are fed and homogenized in the melt mixture, and
in a second stage of the process, the melt mixture is either discharged from the extruder and palletized or heated in a third extruder segment,
wherein the molding composition pellets are melted in a third stage of the process and the pseudoplastic melt is processed in presses, extruders or injection-molding machines with crosslinking to give semifinished products or molded materials, or wherein the melt mixture is heated in a third extruder segment and the pseudoplastic melt is discharged with crosslinking through a die and is drawn off in the form of a semifinished product.

39. The process as claimed in claim 38, wherein the extruder process has at least one extruder whose length is from 30 to 60 D and equipped with side feed equipment for solid and liquid substances and vacuum devolatilization.

40. The process as claimed in claim 38, wherein the melt mixtures composed of melamine resin ethers and of thermoplastics are prepared at melt temperatures of from 100 to 170° C.

41. The process as claimed in claim 38, wherein the mixture components are fed collectively into the feed hopper, or at least one melamine resin ether is fed into the thermoplastic melt after melting of the thermoplastic by way of side-feed equipment, or at least one thermoplastic is fed into the thermoplastic melt after melting of the melamine resin ether by way of side-feed equipment.

42. The process as claimed in claim 38, wherein, in the second extruder segment, melt temperatures of from 100 to 150° C. have been set into the melt mixture.

43. The process as claimed in claim 38, wherein, in the second extruder segment, hardener or thermally decomposing free-radical generator or both are used in the form of masterbatch comprising from 60 to 90% by weight of thermoplastics.

44. The process as claimed in claim 38, wherein at least one of fillers, adsorber materials, inorganic fibers, synthetic fibers, flame retardants, pigments, stabilizers, or auxiliaries are fed into the extruder in the first or second extruder segment or both.

45. The process as claimed in claim 38, wherein, in the third extruder segment, a temperature of from 150 to 240° C. has been set.

46. The process as claimed in claim 37, wherein the plastics product is produced by a sintering process.

47. The process as claimed in claim 46, wherein, in a first stage of the process, mixtures composed of at least one melamine resin ether and of at least one thermoplastic are sintered in high-speed mixers, the sintered mixture is cooled, and, after cooling, hardener or thermally decomposing free-radical generator or both are applied in a drum mixer to the sinter mixture, and, in a second stage of the process, the sinter mixture is melted, and the pseudoplastic melt is processed in presses, extruders, or injection-molding machines with crosslinking to give semifinished products or molded materials.

48. The process as claimed in claim 46, wherein the fillers, adsorber materials, inorganic fibers, or synthetic fibers are sintered concomitantly in the first stage of the process.

49. The process as claimed in claim 46, wherein the residence time in the high-speed mixer is from 3 to 30 min and the final temperature is from 90 to 160° C.

50. The process as claimed in claim 46, wherein the temperatures to which cooling of the sinter mixture takes place are from 50 to 120° C.

51. The process as claimed in claim 46, wherein, in the second stage of the process, the sinter mixture is melted at temperatures of from 150 to 240° C.

52. The process as claimed in claim 46, wherein, in the first stage of the process, at least one of flame retardants, pigments, stabilizers, or auxiliaries are applied in a drum mixer.

53. The process as claimed in claim 37, wherein, at least one melamine resin ether is an etherified melamine resin condensate which is free from hydroxymethyleneamino groups bonded to the triazine rings of the melamine resin condensate and from —NH—CH₂—O—CH₂—NH— groups linking triazine rings, and in which C₁-C₁₈ alcohols or diols with molecular weights of from 62 to 20 000 or both have been used for the etherification of the hydroxymethylamino groups.

54. The process as claimed in claim 38, wherein, as hardener for at least one melamine resin ether, acidifiers of the type represented by blocked sulfonic acids, aliphatic C₄-C₁₈ carboxylic acids; aromatic C₇-C₁₈ carboxylic acids; alkali metal salts or ammonium salts of phosphoric acid; C₁-C₁₂-alkyl ethers or C₂-C₈-hydroxyalkyl esters of C₇-C₁₄-aromatic carboxylic acids, or of inorganic acids; salts of melamine or of guanamines with C₁-C₁₈-aliphatic carboxylic acids; anhydrides, half esters or half amides of C₄-C₂₀ dicarboxylic acids; half esters or half amides of copolymers composed of ethylenically unsaturated C₄-C₂₀ dicarboxylic anhydrides and of ethylenically unsaturated monomers of the type represented by C₂-C₂₀ olefins or C₈-C₂₀ vinylaromatics or both; and/or salts of C₁-C₁₂ alkylamines and, respectively, alkanolamines with C₁-C₁₈-aliphatic, C₇-C₁₄-aromatic, or alkylaromatic carboxylic acids, and also with inorganic acids of the type represented by hydrochloric acid, sulfuric acid, or phosphoric acid, are used.

55. The process as claimed in claim 38, wherein, as the thermally decomposing free-radical generator for the crosslinking of the thermoplastic component, free-radical generators whose thermal decomposition has been concluded below 210° C. are used, selected from the group consisting of acyl peroxides, alkyl peroxides, hydroperoxides, peroxycarbonates, and peresters.

56. A plastics product as claimed in claim 30, for use in the vehicle industry, mechanical engineering, electrical engineering, or electronic products.
